(19) United States
(12) Patent Application Publication
(10) Pub. No.: US 2007/0119975 A1
(43) Pub. Date: May 31, 2007

(54) Method and Apparatus for Reducing the Precipitation Rate of an Irrigation Sprinkler

(76) Inventor: S. Brian Hunnicutt, Vail, AZ (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/465,986

(22) Filed: Aug. 21, 2006

Related U.S. Application Data
(63) Continuation of application No. 11/062,968, filed on Feb. 22, 2005.
(63) Continuation of application No. 10/295,689, filed on Nov. 14, 2002, now Pat. No. 6,921,029.
(60) Provisional application No. 60/360,420, filed on Mar. 1, 2002.
(60) Provisional application No. 60/348,488, filed on Nov. 28, 2001.
(60) Provisional application No. 60/344,398, filed on Jan. 3, 2002.
(60) Provisional application No. 60/360,883, filed on Mar. 4, 2002.

(51) Int. Cl. B05B 15/06; B05B 15/10; A01G 25/06

(52) U.S. Cl. 239/200; 239/201; 239/203; 239/204

(57) ABSTRACT

A fixed nozzle type sprinkler having a flow interrupter assembly that is configured to reduce the water hammer effect is disclosed. A pressure relief valve is disposed to vent fluid when the pressure within the sprinkler exceeds a generally predetermined amount. When the flow interrupter assembly is in its closed position, blocking fluid flow through the nozzle, the pressure in the sprinkler can build up. Once that pressure reaches the generally predetermined amount, the pressure relief valve opens to vent fluid and reduce the pressure within the sprinkler.

### CROSS-REFERENCE TO RELATED APPLICATIONS

This application claims priority of U.S. patent application Ser. No. 11/062,968, filed Feb. 22, 2005, which in turn claims priority from U.S. patent application Ser. No. 10/295,689, filed Nov. 14, 2002 and now issued as U.S. Pat. No. 6,921,029, which in turn claims priority from U.S. patent application Ser. Nos. 60/348,488, filed on Nov. 28, 2001, now expired; 60/344,398, filed on Jan. 3, 2002, now expired; 60/360,420, filed on Mar. 1, 2002, now expired; and 60/360,883, filed on Mar. 4, 2002, now expired. The disclosures of each of the aforementioned patent applications are incorporated by reference herein in their entireties.

### FIELD

This disclosure relates to irrigation sprinklers, and more particularly to a new and improved method and apparatus for reducing the effective precipitation rate of a fixed sprinkler, particularly of the pop-up type.

### BACKGROUND

Probably the most common method of irrigating landscape areas of vegetation is by the use of sprinklers. In a typical irrigation system various types of sprinklers are used to distribute water over a desired area. In general, sprinkler devices are divided into two types, namely rotating stream type and fixed spray pattern type. The stream type sprinkler, commonly referred to as a rotor, trajects a stream of water outwardly from a nozzle, which is rotating slowly over a predetermined arc or complete circle. The spray type sprinkler sprays water from a stationary nozzle, the pattern of coverage being determined by the geometric shape of the discharge passage of the nozzle.

For reasons well known to those involved in the design of irrigation systems, the precipitation rate of the rotor type sprinklers is much lower than the precipitation rate of the fixed nozzle type sprinkler. For proper irrigation of plant life and conservation of water it is extremely important to have a uniform or prescribed amount of water delivered by the irrigation system to a specific area. Because of the difference in precipitation rates of the two types of sprinklers, heretofore it has been necessary to operate the rotor type of sprinkler for a longer time than the spray type sprinkler. In order to accomplish this, it has been necessary to have the two types of sprinklers operated separately whereby each type could be operated for a suitable time to supply the desired total precipitation to the irrigated area. Prior to this invention many attempts have been made to reduce the precipitation rates of spray type sprinklers. Most, if not all of such attempts have been concentrated on the design of the nozzles in order to reduce the rate of flow of water.

The fixed nozzle type sprinklers disclosed in U.S. Pat. No. 6,921,029 addresses this deficiency in prior fixed nozzle type sprinklers by providing a fixed pattern type sprinkler with attainable precipitation rates equivalent to the precipitation rates of rotary stream sprinklers. This advantageously makes it possible to operate rotary and spray type sprinklers on the same supply circuit and for the same length of time, thereby reducing the cost and simplifying the operating of the irrigation system. This is accomplished by reducing the effective time of operation of the sprinkler while using conventional flow rate nozzles by interrupting the flow of water to the sprinkler nozzle.

More specifically, interruption of the flow of water to the sprinkler nozzle is accomplished by turning the water supply to the nozzle on and off in timed durations using a water flow interrupter or valve assembly. The water flow interrupter assembly may be disposed within the riser and be moveable therewith, and functions to periodically shut-off the supply of pressurized water to the nozzle for a predetermined period of time without interrupting the supply of water from the source to the sprinkler. The flow interrupter assembly operates in a highly effective and efficient manner to permit controlled reduction in the effective precipitation rate of the sprinkler, and allows the use of any size nozzle and nozzle pattern without effecting the overall lowered precipitation rate of the sprinkler.

The periodic shut-off of the supply of pressurized water to the nozzle can be accomplished by selectively blocking a fluid flow passage using a sealing member. However, the periodic shut-off of the supply of pressurized water to the nozzle can cause the sprinkler to experience a water hammer effect due to pressure fluctuations within the sprinkler. As the sealing member moves from an open position to a closed position, the flow area between the fluid flow passage and the sealing member continually decreases in correspondence with the position of the sealing member from the fluid flow passage until the sealing member is blocking flow through the opening of the fluid flow passage. When the sealing member is blocking flow through the fluid flow passage, the abrupt change in the flow area between the sealing and the fluid flow passage from greater than zero, immediately prior to blocking, and zero, at the time of blocking, can cause a sudden pressure spike greater than the upstream pressure. More specifically, the pressure spike in the upstream pressure can be caused as the motion energy in the flowing fluid is abruptly converted to pressure energy acting on the components of the sprinkler. This pressure spike can cause the sprinkler to experience a water hammer effect, which can undesirably result in increased stress on the components of the diaphragm valve, as well as other components of the irrigation system, and can lead to premature failure of the components.

The water hammer effect can be exacerbated due to increased pressure fluctuations within irrigation sprinklers having the flow interrupter assembly. Increased pressure fluctuations can be caused by the use of larger radius nozzle sizes, undersized pipe diameters that result in increased water velocities, and large pipe losses that require higher input pressures.

The water hammer effect can also be exacerbated due to increased pressure fluctuations within a circuit having multiple irrigation sprinklers each with a flow interrupter assembly. For example, multiple such irrigation sprinklers can have their flow interrupter assemblies randomly synchronize, which can increase the amount system water flow that is shut-off. Similarly, synchronization of irrigation sprinklers having the flow interrupter assemblies can cause the dynamic pressure to increase and approach the static input pressure as flow demand drops. Moreover, the use of a pressure regulator, such as a pressure regulator that is built into a valve, can cause a lag time in compensating for pressure fluctuations due to the flow interrupter assemblies, which can magnify the resulting pressure waves.

Accordingly, there is a need for a fixed nozzle type sprinkler having a flow interrupter assembly, such as disclosed in U.S. Pat. No. 6,921,029, that is configured to reduce the water hammer effect.

### SUMMARY

A fixed nozzle type sprinkler having a flow interrupter assembly, such as disclosed in U.S. Pat. No. 6,921,029, that is configured to reduce the water hammer effect is disclosed. A pressure relief valve is disposed to vent fluid when the pressure within the sprinkler exceeds a generally predetermined amount. When the flow interrupter assembly is in its closed position, blocking fluid flow through the nozzle, the pressure in the sprinkler can build up. Once that pressure reaches the generally predetermined amount, the pressure relief valve opens to vent fluid and reduce the pressure within the sprinkler. Thus, when the flow interrupter assembly moves from its open position to its closed position, the reduced pressure in the sprinkler can result in a reduced water hammer effect.

The pressure relief valve may automatically open in response to the fluid pressure within the sprinkler exceeding the generally predetermined amount. The pressure relief valve can be incorporated into the case of a sprinkler, or may be incorporated into a riser of the sprinkler.

### BRIEF DESCRIPTION OF THE DRAWINGS

FIG. 1 is a front elevation view of a first embodiment of a pop-up irrigation sprinkler having a flow stop valve and a pressure relief valve showing a riser extending from a case;

FIG. 2 is a top plan view of the irrigation sprinkler of FIG. 1;

FIG. 3 is a cross-sectional view of the irrigation sprinkler of FIG. 1 taken along line III-III of FIG. 2;

FIG. 4 is a detailed cross-sectional view of the irrigation sprinkler of FIG. 3 showing a pressure relief valve in a closed position;

FIG. 5 is a detailed cross-sectional view of the irrigation sprinkler of FIG. 3 showing a pressure relief valve in an open position;

FIG. 6 is an exploded view of the flow stop valve of FIG. 1;

FIG. 7 is a cross-sectional view of the flow stop valve of FIG. 1 in a closed position with inner and outer pistons in extended positions;

FIG. 8 is a cross-sectional view of the flow stop valve of FIG. 1 with the inner piston in the extended position and the outer piston in a retracted position;

FIG. 9 is a cross-sectional view of the flow stop valve of FIG. 1 in an open position with the inner and outer pistons in the retracted positions;

FIG. 10 is a cross-sectional view of a second embodiment of a pop-up irrigation sprinkler having a flow stop valve and a pressure relief valve showing a riser extending from a case and the pressure relief valve in a closed position;

FIG. 11 is a cross-sectional view of the sprinkler of FIG. 10 showing the pressure relief valve in an open position;

FIG. 12 is a graph comparing the maximum upstream pressures for the sprinklers of FIG. 1 having both the pressure relief valve and the flow stop valve and sprinklers having only the flow stop valve for a period of about 130 seconds;

FIG. 13 is a detailed view of the period from 20 to 50 seconds of the graph of FIG. 12; and

FIG. 14 is a graph comparing the inlet pressure, pressure inside the flow stop valve, and pressure upstream of a nozzle of the sprinkler for the sprinkler of FIG. 1.

### DETAILED DESCRIPTION THE DRAWINGS

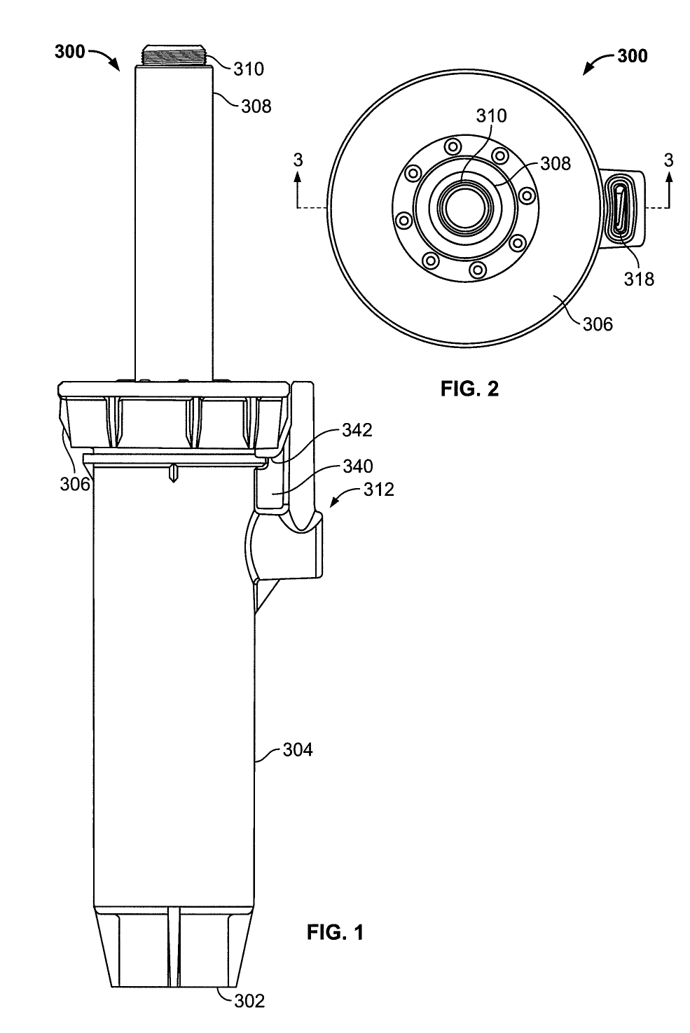

Pop-up spray-type sprinklers 300 and 400 for watering a fixed area around the sprinkler is disclosed and illustrated in FIGS. 1-5, 10 and 11. The sprinklers 300 and 400 are configured for reduced precipitation, permitting it to be used on the same circuit as a rotor, and for reducing the water hammer effect by venting excess pressure.

In a first embodiment, the sprinkler 300 includes a cylindrical case 304 adapted to be buried in the ground. A bottom end of the case 304 has a water supply inlet 302 at the bottom for attachment to a source of pressurized water. A top end of the case 304 has an overlying cover 306. A hollow tubular riser 308 is disposed for reciprocation between an extended upper operating position, as shown in FIG. 1, and a lower inoperative position retracted inside the case 304. The riser 308 has an internal bore 356, extending between a lower end 358 disposed within the case 304 and an upper end 310 adapted to project above the case 304 and cover 306 when in the operative position. The upper end 310 of the riser 308 is adapted for mounting of a removable spray nozzle.

A conventional retract spring 360, herein a coil spring, is disposed around the riser 308 within the casing 304, and has one end abutting the underside of the cover 306 and the other end abutting an enlarged upwardly facing radial surface surrounding the lower end 358 of the riser 308. The retract spring 360 operates to bias the riser 308 to the inoperative, retracted position within the case 304 when no water pressure is supplied to the sprinkler 300, and to compress to the position shown in FIG. 1 when water pressure is admitted to the sprinkler 300 via the inlet 302, and the riser 308 is extended to the upper, operative position.

When in normal use, pressurized water enters the inlet 302 and flows through the case 304 and the riser 304 to the upper end 310 where it is ejected outwardly away from the sprinkler 300 through the nozzle in a fan-shaped spray pattern and at a precipitation rate determined by the spray nozzle and water supply pressure utilized. Depending on the type of nozzle installed on the riser 308, the spray pattern can be any shape, typically from a full circle to a small pie-shaped part circle, such as a quarter circle pattern. When the supply of pressurized water is shut off, the retract spring 360 moves the riser 308 downwardly to the retracted inoperative position inside the case 304. It should be noted that each time the supply of pressurized water is admitted to the case 304, the rise in internal pressure causes the riser 308 to extend upwardly to the operative position, and as water pressure builds within the riser, water ejected though the nozzle results in a spray pattern that initially extends radially outwardly from adjacent the sprinkler 300 to the maximum distance away from the sprinkler for the specific nozzle and supply pressure utilized. On shutting off the supply of pressure to the inlet 302 of the case 304, the water pressure decreases so that as the riser 308 retracts to the inoperative position within the case 304, the spray pattern decays from the maximum radial distance back to the area adjacent the sprinkler. Thus, with each cycle of sprinkler operation, the area around the sprinkler 300 is watered from adjacent the sprinkler out to the maximum radial distance of throw of the nozzle.

A water flow interrupter or flow stop valve, generally designated by reference numeral 350, is disposed within the riser 308 and is moveable therewith, and which functions to periodically shut-off the supply of pressurized water between the lower end 352 and upper end 310 of the riser 308, and thus to the nozzle, for a predetermined period of time without interrupting the supply of water from the source to the inlet 302 of the sprinkler 300. The flow interrupter assembly 350 operates in a highly effective and efficient manner to permit controlled reduction in the effective precipitation rate of the sprinkler 300, and allows the use of any size nozzle and nozzle pattern without effecting the overall lowered precipitation rate of the sprinkler. Moreover, the flow interrupter 350 is relatively simple in construction, reliable in use and economical to manufacture, yet can be utilized with virtually any spray type sprinkler where it is desirable to reduce and control the precipitation rate during an irrigation cycle without having to turn the supply of pressurized water from the source on and off. The operation of the flow interrupter assembly 350 may be of the types described in greater detail in U.S. Pat. No. 6,921,029, the disclosure of which is incorporated by reference in its entirety, or as discussed herein. An in-stem pressure regulator 352 may optionally be included, as well as a Seal-A-Matic™ check valve.

When the flow interrupter assembly 350 functions to shut off the fluid flow through the riser 308, fluid pressure upstream of the flow interrupter assembly 350 can undesirably increase. This increased water pressure upstream of the flow interrupter assembly 350 can cause the fluid pressure in the sprinkler 300 to increase, and can increase the water hammer effect. However, the water hammer effect is reduced by virtue of a pressure relief valve 312 that reduces pressure in the sprinkler 300 when the flow interrupter assembly 350 is blocking fluid flow to the nozzle. The pressure relief valve 312 opens to vent fluid and reduce the fluid pressure in the sprinkler 300 when the fluid pressure in the sprinkler 300 exceeds a generally predetermined amount.

The pressure relief valve 312 is positioned to vent fluid from the case 304 when in its open position, and to block fluid from exiting the case 304, other than through the riser 308, when in its closed position. The pressure relief valve 312 includes an opening 316 that is selectively blocked by a seal 324 attached to a plunger 322. The plunger 322 is biased by a spring 326 to urge the seal 324 into a position blocking the opening 316, as illustrated in FIG. 4. When the fluid pressure in the sprinkler increases beyond a predetermined amount, the fluid pressure urges the plunger 322 and attached seal 324 away from the opening 316, against the biasing force of the spring 326, to permit fluid to vent from the sprinkler 300 through the opening 316, as illustrated in FIG. 5.

The amount of pressure at which the pressure relief valve 312 will open can be generally predetermined. That is, the pressure relief valve can be selected to open when certain predetermined pressures within the sprinkler 300 are exceeded. Due to operating variations of the sprinkler 300, the predetermined pressure at which the pressure relief valve 312 will open likely will be within a range of pressures, and thus is generally predetermined. Some variation from the predetermined pressure is expected during operation.

For a given predetermined amount of pressure, the pressure relief valve 312 can be configured to shift from its closed position to its open position to vent fluid. More specifically, the area of the opening 316 and the amount of force exerted by the spring 326 can be configured to result in the pressure relief valve 312 opening for a given predetermined pressure according the following formula: F=(P)(A), where P is the predetermined pressure, F is the spring force, and A is the area of the opening. By way of example, for an opening that is about 0.50 inches in diameter and a desired pressure of 130 psi, a spring force of about 25.5 pounds is necessary to open the pressure relief valve 312.

Turning now to more of the details of the pressure relief valve 312, the plunger 322 is disposed in a bore 314 having a diameter that is larger than the diameter of the opening 316. At the intersection of the opening 316 and the bore 314, a recessed annular groove 336 is positioned facing the bore 314, as illustrated in FIGS. 4 and 5. Between the groove 336 and the opening 316 is a raised annular rim 338. The raised annular rim 338 is positioned to be engaged by the seal 324 positioned on the plunger 322. The plunger 322 has a head 323 and a shaft 330, with the head 323 having a larger diameter than the shaft 330. The head 323 of the plunger 322 has a recessed region 334 with a diameter sized to accommodate the seal 324 and to position the seal 324 for engagement with the rim 338 to block the opening 316. Opposite the recessed region 334, the plunger 322 has a shaft 330 with an inner blind bore 332. A disk 320 is positioned in the bore 314, opposite the opening 316, to close the bore 314. The disk 320 has an inwardly projecting guide pin 328 that is sized to fit at least partially within the blind bore 314.

Surrounding the shaft 330 is a valve spring 326, which is positioned between the disk 320 and the head 323 of the plunger 322 to bias the plunger 322 away from the disk 320 and toward the opening 316 to block the opening 316 by engagement between the seal 324 and the rim 338. When the biasing force of the spring 326 is overcome by the pressure in the sprinkler 300 acting on the seal 324 via the opening 316, the plunger 322 and attached seal 324 are moved away from the opening 316 to permit fluid flow from the interior of the case 304, through the opening 316 and into the bore 314.

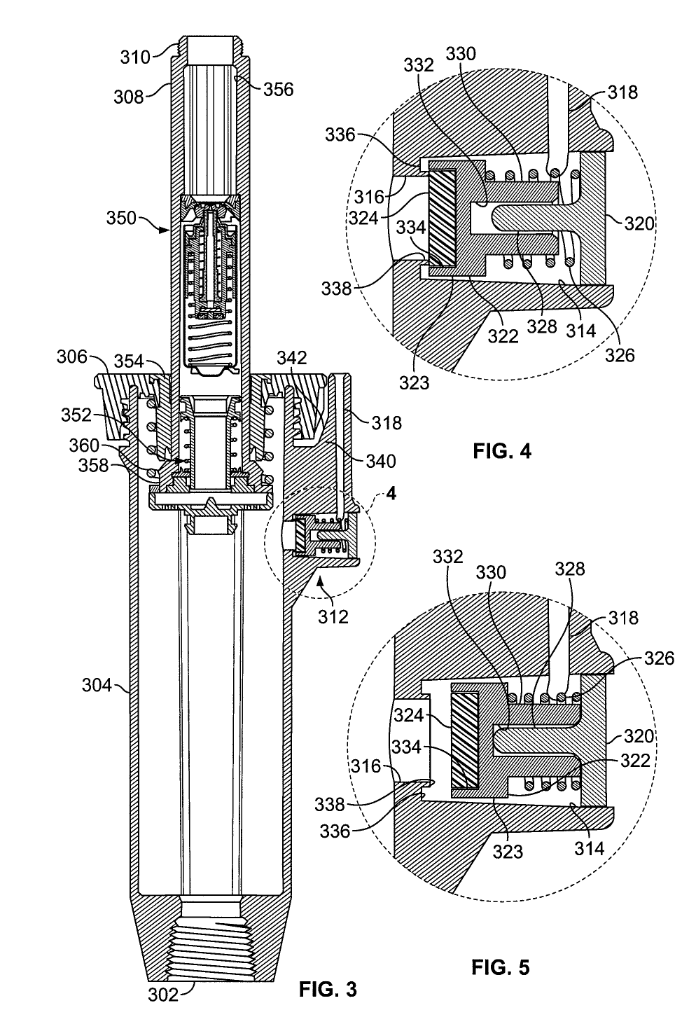

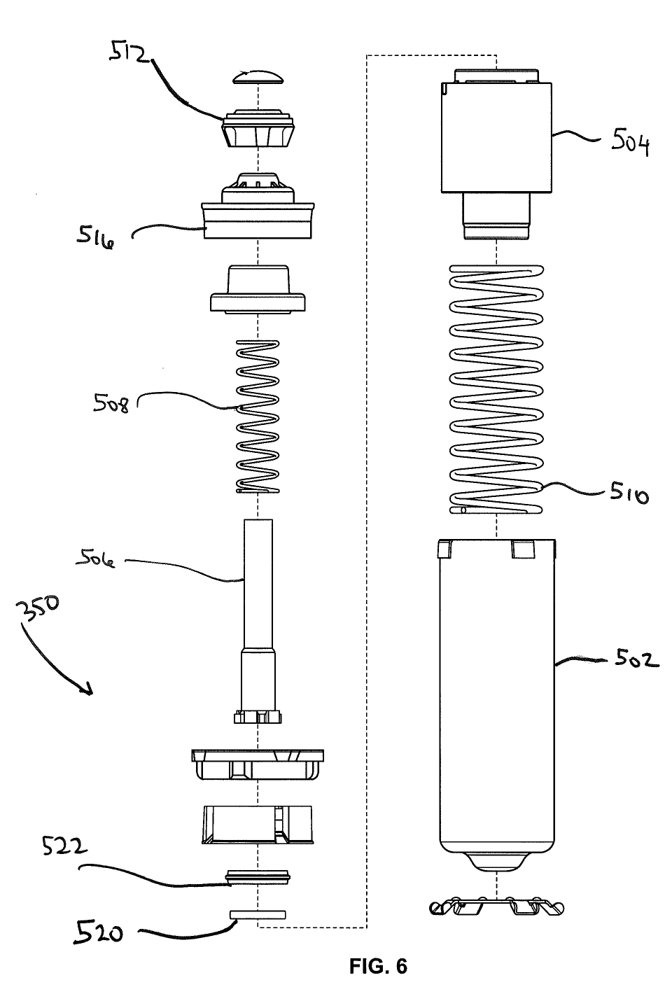

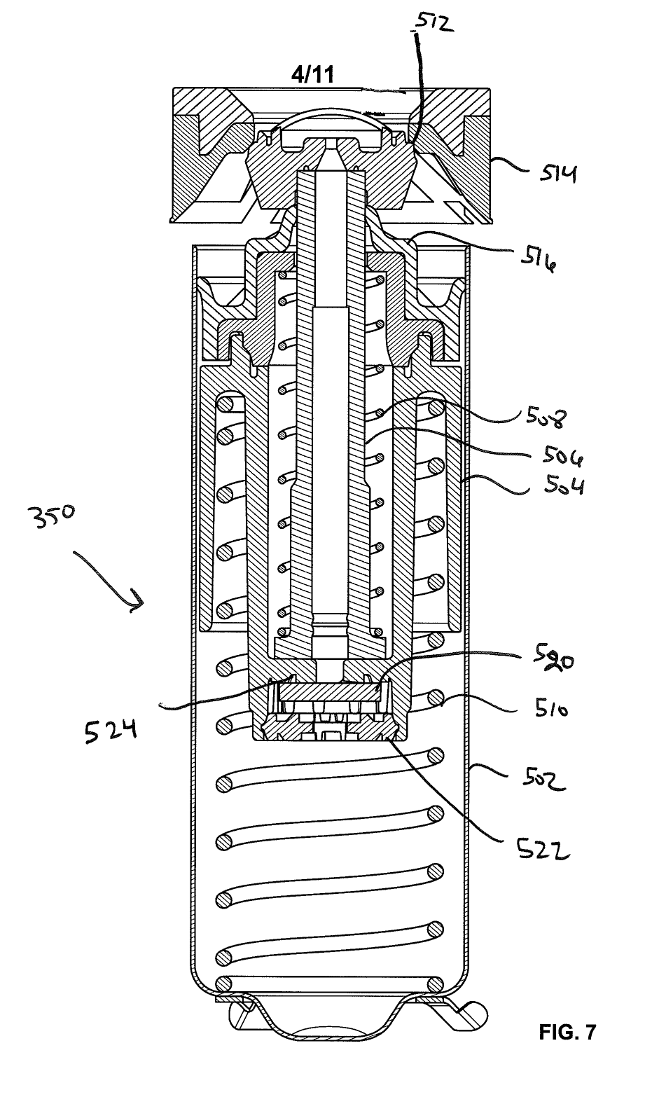

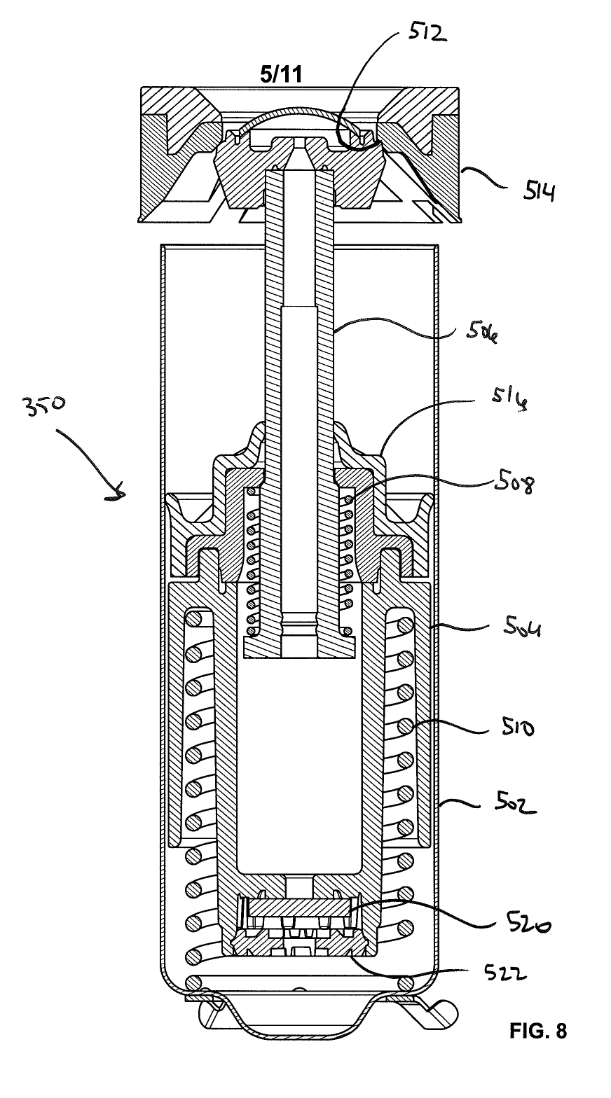

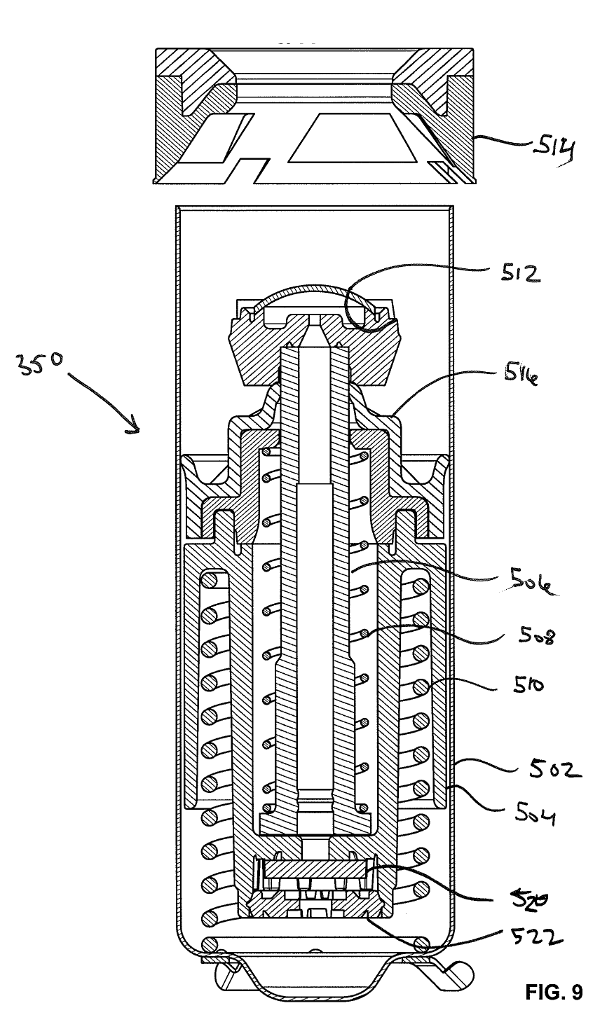

A vent passage 318 intersects the bore 314 and provides a path for fluid exiting the case 304 to flow through to atmosphere. The vent passage 318 preferably, though not necessarily, directs the vented fluid above-ground when the case 304 is at least partially buried underground in order to reduce erosion of the ground adjacent the exit of the vent passage 318. As can be seen in FIG. 3, the vent passage 318 extends upwardly to a level approximately even with an outwardly facing surface of the cap 306. A diffuser or redirecting feature may be placed at the opening of the vent passage 318 to either diffuse or redirect the exiting fluid.

In the illustrated embodiment of FIGS. 1-5, the vent passage 318 and bore 314 are integrally molded with the case 304, and are connected to the case 304 via an extension 340. The extension 340 includes a cut-out 342 to accommodate a depending portion of the cap 306. The disk 320 may be sonically welded into the bore 314, press-fit into the bore 314, threaded into the bore 314, attached with adhesive, or other such ways of joining. Alternatively, the disk 320 may be integrally molded with the case 304 or other components of the pressure relief valve 312.

Comparison tests were performed between a sprinkler having the pressure relief valve 312 and a control sprinkler lacking the pressure relief valve 312. In both instances, the sprinkler was a Rain Bird Model No. 1812 having a Seal-A-Matic™ check valve and an in-stem pressure regulator. The sprinkler having the pressure relief valve 312 was tuned to vent at the generally predetermined pressure of 130 psi. This was accomplished by having a vent opening of about 0.50 inches in diameter and a spring force of about 25.5 pounds. In the tests, the piping was 0.50 inch diameter PVC.

In the first comparison test, a pair of the same type of sprinklers were on the same circuit with a pump and a valve, and the pressure at the pump was about 103 psi. The maximum pressures were measured at start-up were measured before the valve, after the valve and at the end of the line. As set forth in the below table, the maximum pressure upon start-up both after the valve and at the end of the line are significantly reduced in the sprinkler with the pressure relief valve as compared to the control. This correlates to a decreased water hammer effect during start-up.

| | Start-up Pressure Maximum | | |
|---|---|---|---|
| | Before Valve | After Valve | End of Line |
| Control | 143 psi | 195 psi | 292 psi |
| With Pressure Relief Valve | 131 psi | 141 psi | 161 psi |

In the second comparison test, eight of the same type of sprinklers were on the same circuit with a pump and a valve, and the pressure at the pump was about 103 psi. The maximum pressures during operation were measured before the valve, after the valve and at the end of the line. As set forth in the below table, the maximum pressure upon start-up both after the valve and at the end of the line are significantly reduced in the sprinkler with the pressure relief valve as compared to the control. This correlates to a decreased water hammer effect during operation.

| | Operating Pressure Maximum | | |
|---|---|---|---|
| | Before Valve | After Valve | End of Line |
| Control | 140 psi | 159 psi | 243 psi |
| With Pressure Relief Valve | 131 psi | 137 psi | 152 psi |

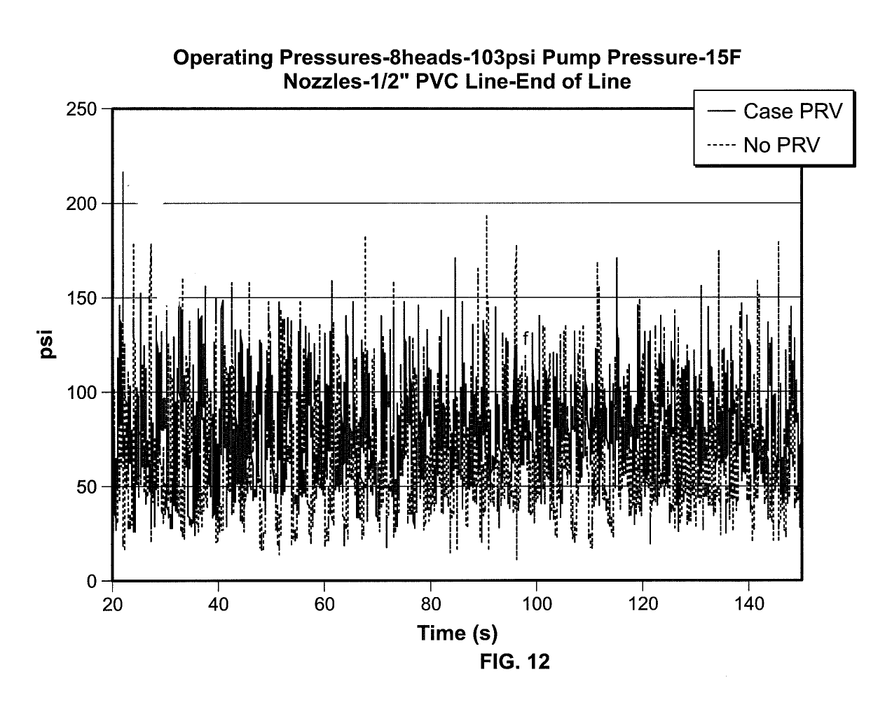

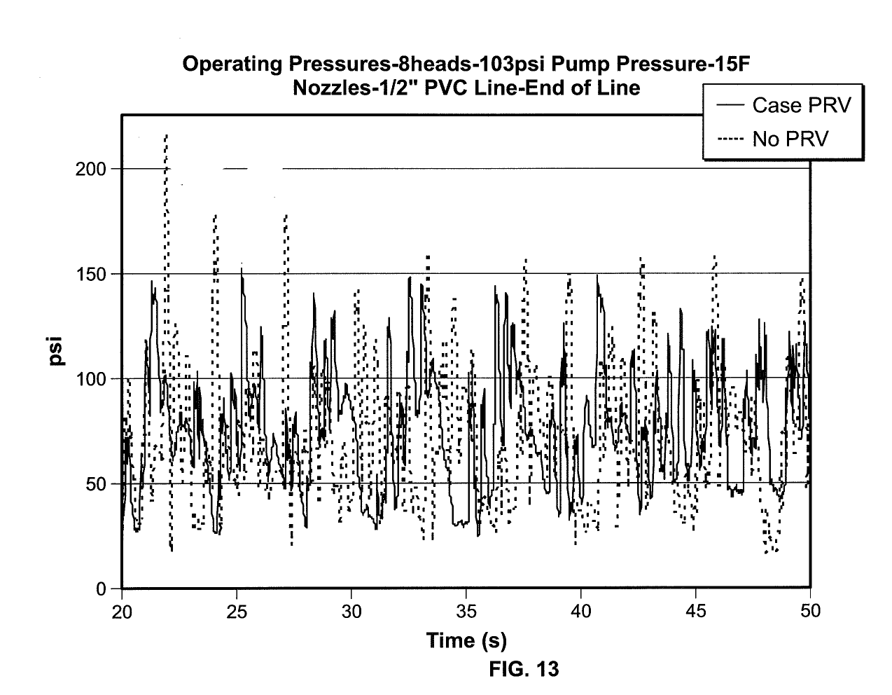

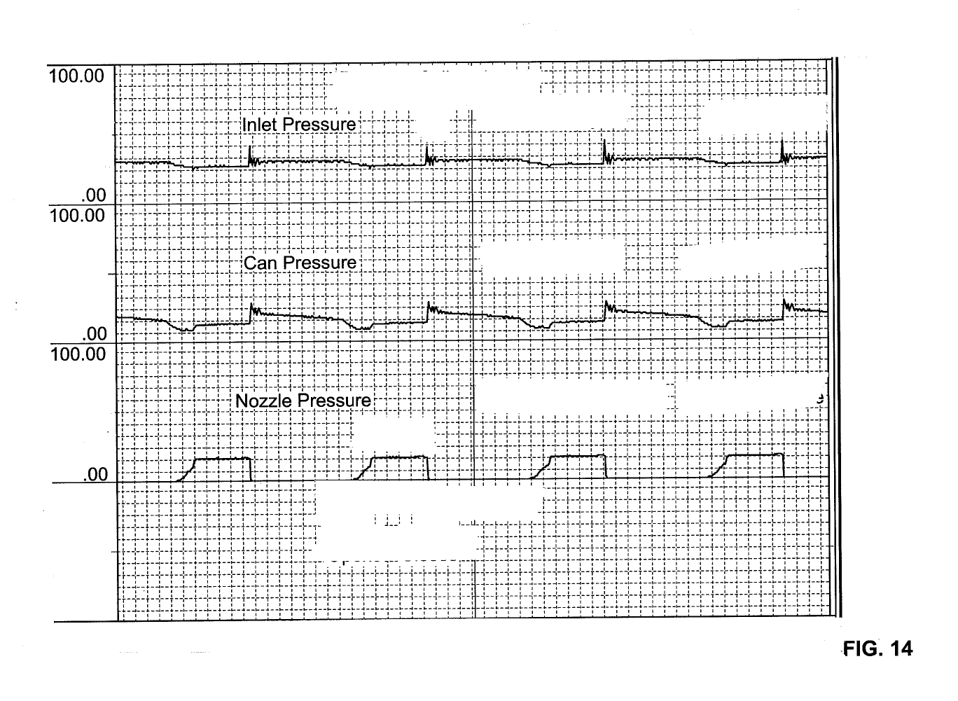

As shown in the graph of FIG. 14, the pressure at the inlet increases to its maximum in conjunction with the decrease in pressure downstream of the flow interrupter assembly 350 and upstream of the nozzle. That is, the maximum pressure upstream of the flow interrupter assembly 350 occurs when the flow interrupter assembly 350 closes. However, the sprinkler 300 having both the pressure relief valve 312 and the flow interrupter assembly 350 has consistently lower maximum operating pressures, as shown in the graphs of FIGS. 12 and 13 comparing the maximum upstream pressures for the sprinklers 300 having both the pressure relief valve 312 and the flow interrupter assembly 350 and sprinklers having only the flow stop valve. The data used to generate this graph was measured at the end of the line of a circuit having eight sprinklers, a pump operating at 103 psi, 0.50 inch PVC piping and a nozzle size 15F. As is expected, the highest maximum pressures are experienced soon after start-up. Both soon after start-up and thereafter, the sprinkler 300 having the pressure relief valve 312 has reduced maximum operating pressures, which in turn, and as discussed above, can advantageously lead to a reduced water hammer effect.

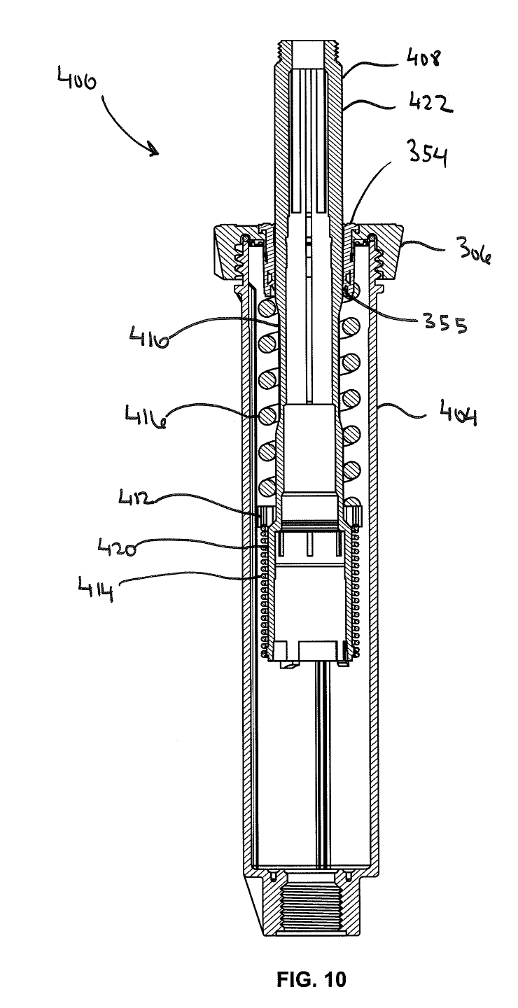

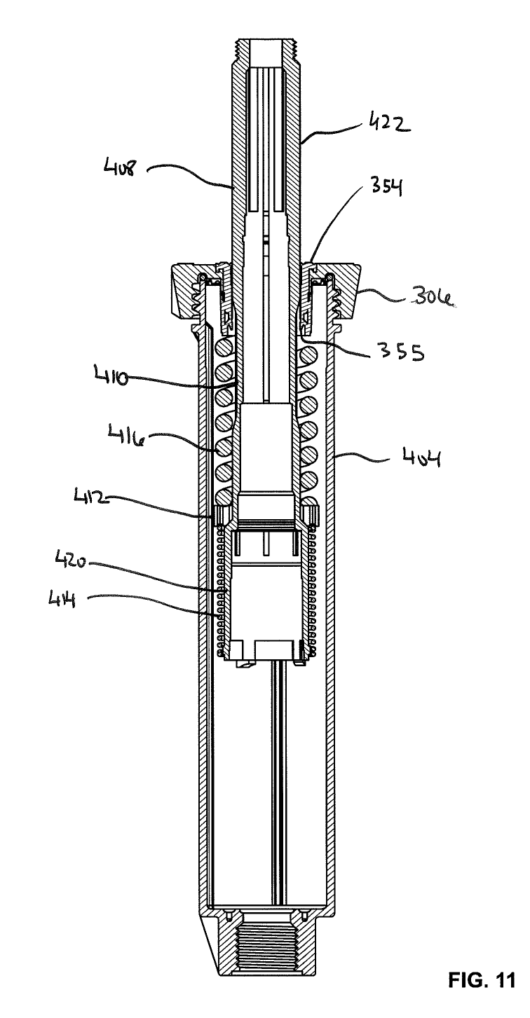

Instead of incorporating a pressure relief valve 312 into the case 304, a pressure relief valve may be incorporated into a modified riser 408, as illustrated in the sprinkler 400 of FIGS. 10 and 11. The pressure relief valve of the sprinkler 400 is configured to vent excess fluid when the pressure in a case 404 of the sprinkler 400 exceeds a generally predetermined pressure in order to reduce pressure in the sprinkler 400, and can be combined with the flow interrupter assembly 350. Although not illustrated, it is understood that the flow interrupter assembly 350 can be positioned in the modified riser 408.

The modified riser 408 has an upper span 422 of typical diameter, a reduced diameter span 410, and an enlarged diameter span 420. During normal operation, when the riser 408 is extended from the case 404 and when the operating pressure in the case 404 of the sprinkler 400 does not exceed the generally predetermined pressure, the upper span 422 of the riser 408 contacts a lip 355 of a seal 354 of the cap 406, as illustrated in FIG. 10, to restrict fluid from exiting between the riser 408 and the lip 355. However, when the pressure in the case 404 increases beyond the generally predetermined pressure, the riser 408 extends further from the case 404 to a vent position such that the lip 355 of the seal 354 is adjacent to but spaced from the reduced diameter span 410 of the riser 408, as illustrated in FIG. 11, to permit fluid to exit between the riser 408 and the lip 355 and thereby vent fluid to reduce pressure in the case 404.

A spring retention ring 412 is disposed around the riser 408 to provide a surface against which a retract spring 414 and a pressure relief spring 416 abut in order to bias the riser 408. The retention ring 412 may be freely floating on the riser 408, but restricted from passing from the end of the riser 408 by the enlarged diameter span 420. More specifically, the retract spring 414 is positioned between an end of the riser 408 and the retention ring 412 to bias the riser 408 into a retracted position within the case 404. During normal operating pressures within the case 404, the riser 408 is biased against the force of the retract spring 414 into the extended position where the upper span 422 of the riser is engaged by the lip 355 of the seal 354. The pressure relief spring 416 is positioned between the cap 406 and the retention ring 412 to bias the riser 408 against further extension from the extended position. As discussed above, when the pressure in the case 404 increases beyond the generally predetermined pressure, the riser 408 extends further from the case 404 to the vent position, against the biasing force of the pressure relief spring 416, such that the lip 355 of the seal 354 is adjacent to but spaced from the reduced diameter span 410 of the riser 408. The spring force of the retract spring 414 is less than the spring force of the pressure relief spring 416, such that during normal operating conditions the riser 408 does not exceed its extended position prematurely. The amount of the spring force of the pressure relief spring 416 can be determined similarly to that for the pressure relief valve 312. That is, by multiplying the desired venting pressure by the area being acted upon by the pressure, in this embodiment, the area of the riser 408 acted upon the operating pressure in the case 404 of the sprinkler 400.

Turning now to details of a specific example of the flow interrupter assembly 350, the assembly includes a cartridge cylinder 502 having an outer piston 504 reciprocal therein and an inner piston 506 being reciprocal in the outer piston 504. A spring 508 biases the inner piston 506 from the outer piston 504, and a spring 510 biases the outer piston 504 from the cartridge cylinder 502. A valve head 512 of the inner piston 506 is configured to abut a valve seat 514 maintained in the riser 308 to block fluid from flowing past the assembly 350 when the biasing forces of the springs 508 and 510 are not exceeded.

The valve head 512 has a convex upper surface and, during pressurization of the sprinkler, the fluid flow is directed against the underside of the valve head 512 by an inclined surface of the valve seat 514. The upper convex surface of the valve head 512 may be shaped liked a portion of a sphere, and the valve seat 514 may be shaped like the frustum portion of a cone. The use of this rounded valve head 512 and inclined valve seat 514 design facilitates the use of the low precipitation rate device at both relatively high and low source pressure conditions.

During operation, fluid flows upward between the case 304 and the flow interrupter assembly 350. To facilitate this fluid flow, a plurality of internal ribs may be positioned inside the case 304. The flow interrupter assembly 350 can be abutted by the ribs, leaving fluid flow paths between the case 304 and the fluid interrupter assembly 350. The upwardly flowing fluid impinges on the inclined surface of the valve seat 514, which redirects the fluid flow toward an upper surface 516 of the outer piston 504. The impact of the redirected fluid on the upper surface 516 of the outer piston 504 urges outer piston 504 to retract against the biasing force of the spring 510, while the fluid also impacts the underside of the valve head 512 to urge the same against the inclined surface of the valve seat 514. When the outer piston 504 is retracted in the cartridge cylinder 502, the spring 508 is compressed and urges the inner piston 506 into a retracted position relative to the outer piston 504, and thereby moves the valve head 512 away from the valve seat 514 to permit fluid to flow therepast. However, as fluid flows past the valve seat 514, the fluid pressure acting on the upper surface 516 of the outer piston 504 is reduced, and the spring 510 biases the outer piston 504 along with the inner piston 506 such that the valve head 512 abuts the valve seat 514 to block fluid flow.

The configuration of the valve head 512 and valve seat 514 helps prevent the assembly 350 from stalling, or ceasing to operate, at difference pressure conditions. When the valve head 512 moves slowly at either opening or closing, fluid turbulence may create force or pressure balance conditions that cause the valve head 512 to stop between the open and closed positions, leaving the assembly 350 partially open. In ordinary operation, the assembly 350 may stall at different pressure conditions depending on the stiffness of the springs 508 and 510 that are used to open the valve head 512. When the springs 508 and 510 have a low spring coefficient, it will open the valve head 512 in low pressure conditions but may not be sufficiently stiff to quickly and completely pull the valve head 512 through turbulence in high pressure conditions. On the other hand, when the springs 508 and 510 have a high spring coefficient, they may not close the valve head 512 quickly enough through turbulent flow. To avoid stalling resulting from fluid turbulence, it can be desirable to move the valve head 514 quickly between open and closed positions.

The disclosed embodiment of the assembly 350 facilitates reduced stalling by using a spring 508 having a relatively high spring coefficient in conjunction with a valve head 512 and valve seat 514 configured to allow fluid flow to assist in closing the valve. The relatively stiff spring 508 facilitates the assembly 350 being opened quickly in both low and high pressure conditions. The use of an inclined valve seat 514 facilitates the assembly 350 being closed quickly by directing fluid flow against the underside of the valve head 512 to provide additional force on the valve head 512 at the time of closing. The valve head 512 is shaped to have an upper convex surface to provide a profile that facilitates the valve head 512 moving through turbulence more easily than a flat valve head design. Thus, the assembly 350 can move quickly through turbulence at both the point of opening and the point of closing.

In a flat valve design, the fluid approaching the valve as the valve head is approaching the closed position tends to impact the valve head in a horizontal manner, given the absence of an inclined valve seat. As a result, the momentum of the fluid does not provide much force to the valve head and does not contribute significantly to closing the valve. In the current embodiment, in contrast, the valve seat 514 is inclined to allow the fluid to impact the underside of the valve head 512 more directly, thereby urging it to close. This aspect is especially beneficial at high pressure conditions where the fluid flow provides greater force on the valve head 512 than at lower pressure conditions.

In this rounded valve head and inclined valve seat design, the valve head 512 also includes circular ribs and pockets, which are located on the convex upper surface of the valve head 512. These circular ribs and pockets are positioned on the convex upper surface to change fluid pressure and velocity at the valve head 512. Gradual change in pressure and velocity can tend to increase the likelihood that the assembly 350 will stall, i.e., become stuck in a partially open position. The use of circular ribs and pockets results in a more drastic change in pressure and velocity, which can decrease the occurrence of stalling.

The low precipitation rate devices described herein reduce the precipitation rate by causing intermittent operation of the sprinkler or precipitation device. The duty cycle, or ratio of precipitation time to non-precipitation time, describes how much the precipitation has been decreased. For example, a 15H nozzle has a precipitation rate of 1.58 inches/hour at 30 pounds per square inch (psi) input pressure. A device having a 38% duty cycle reduces the precipitation rate to about 0.6 inches per hour. The reduced precipitation rate more closely matches the typical soil intake rate of water, thereby reducing water run-off and wasted water.

If the duty cycle is constant regardless of source pressure, the precipitation rate will increase as pressure decreases. In other words, the precipitation rate can vary as the source pressure varies. The change in precipitation rate as a function of pressure for a 15H nozzle and a 38% duty cycle can vary between 0.60 and 0.80 inches per hour as the pressure increases from 15 to 30 psi.

The above embodiments of the invention preferably use a linear emitter design to compensate for this change in precipitation rate and to make the precipitation rate relatively constant, regardless of changes in pressure. As described in the above embodiments, the length of time during which the sprinkler or low precipitation rate device is in the “off,” or not precipitating, condition is controlled by an emitter. By designing the emitter to have a variable flow rate with a lower flow rate at lower pressure, the “off” time can be increased, which in turn reduces the precipitation rate of the device. Thus, by adjusting the flow rate at different pressures, the emitter can be linearized, i.e., provide a relatively constant precipitation rate regardless of pressure.

For example, the linear emitter duty cycle can be increased from approximately 0.30 to 0.40 as the pressure increases from 15 to 30 psi. By changing the duty cycle as a function of pressure, the precipitation rate can be maintained at a relatively constant level regardless of pressure. The precipitation rate of the 15H nozzle with linear emitter can be relatively constant at about 0.60 inches per hour.

The linear emitter design can facilitate bi-directional flow of fluid in and out of the emitter. Further, it can operate over a wider pressure range, such as 10 to 125 psi with surges up to 300 psi, than typical drip emitters, which are designed to operate in pressure ranges of 15 to 60 psi. The emitter is also designed to operate at faster operating cycles with frequent pressure changes than are typical emitters.

The linear emitter design uses a variable orifice to create a pressure compensating flow control. It uses a specially shaped restriction orifice that reacts with pressure differential displacement of an elastic diaphragm 520, which may be held in place using a retainer 522. The linear emitter uses a V-shaped groove 524 that has a constantly changing profile, and may extend radially outward.

The drawings and the foregoing descriptions are not intended to represent the only forms of the sprinkler incorporating a pressure relief valve in regard to the details of construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation. For example, although the foregoing benefits may be achieved in the presently-disclosed sprinkler having a pressure relief valve, other pressure relief valves may be configured differently and still result in these benefits.

1. A irrigation sprinkler having a tubular case with water inlet connection for coupling the sprinkler to a pressurized source of water and a cap closing an end of the case, an extensible riser having an opening at one end disposed in the case and a spray nozzle at an opposite end, the riser having an extended position where the riser extends through an opening in the cap and a retracted position, and a valve assembly alternating between an open position permitting water to exit the spray nozzle when the riser is in the extended position and a closed position blocking water from exiting the spray nozzle when the riser is in the extended position, the irrigation sprinkler comprising a pressure relief valve positioned to vent water from within the irrigation sprinkler when a generally predetermined water pressure within the irrigation sprinkler is exceeded.

2. The irrigation sprinkler of claim 1, wherein the pressure relief valve is configured to open to vent water from within the irrigation sprinkler through a vent opening when the generally predetermined water pressure is exceeded and to close to block the vent opening when the generally predetermined water pressure is not exceeded.

3. The irrigation sprinkler of claim 2, wherein the vent opening is formed in the riser.

4. The irrigation sprinkler of claim 3, wherein the cap has a seal surrounding the riser, the seal restrict fluid to exiting the riser through the spray nozzle when the riser is in the extended position and the vent opening is positioned on a side of the seal adjacent the case, the riser having an further extended position where the vent opening is positioned on a side of the seal opposite the case.

5. The irrigation sprinkler of claim 4, wherein a spring biases the riser to its retracted position, the spring having a force selected to maintain the riser in the extended position until the generally predetermined water pressure is exceed.

6. The irrigation sprinkler of claim 3, wherein the vent opening is formed in the case.

7. The irrigation sprinkler of claim 6, wherein the pressure relieve valve comprises a plunger biased by a spring to engage a seat to close the vent opening when the generally predetermined water pressure is not exceeded, the plunger being movable away from the seat to open the vent opening when the generally predetermined water pressure is exceeded.

8. The irrigation sprinkler of claim 6, wherein the vent opening includes a vent passage downstream of the pressure relief valve.

9. The irrigation sprinkler of claim 8, wherein the vent passage includes a segment extending parallel to a longitudinal axis of the case.

10. The irrigation sprinkler of claim 9, wherein the vent passage has an opening adjacent the cap.

11. A fixed spray type pop-up irrigation sprinkler comprising:
a flow interrupter for periodically blocking substantially all the flow of water through the sprinkler during an irrigation cycle; and
means for venting water from within the irrigation sprinkler when a generally predetermined water pressure within the sprinkler is exceeded during the irrigation cycle.

12. In an irrigation sprinkler of the type comprising a casing having a water inlet connection at the bottom for coupling the sprinkler with a pressurized source of water and a cap at the top end, and an extensible tubular riser having a water directing bore disposed within the case for movement between a retracted inoperative position within the casing and an extended operative position projecting through the cap out of the casing, the riser including a spray nozzle at its upper end and an entrance end disposed within the casing below the cap, the riser serving to direct water from the source to the nozzle for irrigating an area extending outwardly from the sprinkler, the sprinkler comprising:
a flow stop valve assembly coupled to the entrance end of the riser within the casing including a valve head adapted to move between an open and a closed position, respectively unblocking and blocking the entrance end of the riser, and a lost motion piston and cylinder assembly coupled to said valve head for moving said valve head between said open and closed positions, said lost motion piston and cylinder assembly including a piston cyclically moveable within a cylinder between an upper and a lower position for effecting closing and opening, respectively, of said valve head;
a water flow path extending between said cylinder below said piston and said bore of said riser above said valve head;
a first flow control device disposed in said water flow path for limiting the rate of flow of water through said water flow path when said piston is moving downwardly within said cylinder and a second flow control device disposed in said flow path for limiting the rate of flow of water through said water flow path when said piston is moving upwardly within said cylinder, whereby the time during which said valve head is in said closed position is controlled by said first flow control device, and the time during which said valve head is in the open position is controlled by said second flow control device; and
a pressure relief valve positioned to vent water from within the irrigation sprinkler when a generally predetermined water pressure within the sprinkler is exceeded.

13. The irrigation sprinkler of claim 12, wherein the pressure relief valve is configured to open to vent water from within the irrigation sprinkler through a vent opening when the generally predetermined water pressure is exceeded and to close to block the vent opening when the generally predetermined water pressure is not exceeded.

14. The irrigation sprinkler of claim 13, wherein the vent opening is formed in the riser.

15. The irrigation sprinkler of claim 14, wherein the vent opening is spaced from a seal when the generally predetermined water pressure is exceeded.

16. The irrigation sprinkler of claim 13, wherein the vent opening is formed in the case.

17. The irrigation sprinkler of claim 16, wherein the pressure relieve valve comprises a plunger biased by a spring to engage a seat to close the vent opening when the generally predetermined water pressure is not exceeded, the plunger being movable away from the seat to open the vent opening when the generally predetermined water pressure is exceeded.
